(19) United States
(12) Patent Application Publication
(10) Pub. No.: US 2026/0131354 A1
(43) Pub. Date: May 14, 2026

(54) INSTALLATION FOR IMPREGNATING A POROUS MATERIAL WITH POWDER

(71) Applicant: FIBROLINE, LIMONEST (FR)

(72) Inventor: Joric MARDUEL, CHAZAY D'AZERGUES (FR)

(21) Appl. No.: 19/121,645

(22) PCT Filed: Oct. 16, 2023
(86) PCT No.: PCT/EP2023/078593

§ 371 Date: Apr. 16, 2025

(30) Foreign Application Priority Data
Oct. 19, 2022 (FR) FR2210825

(51) Int. Cl. B05D 1/00

(52) U.S. Cl. CPC B05D 1/007

(57) ABSTRACT

The invention relates to an installation (100) for impregnating a porous material (14) with powder (12), comprising: first and second electrodes (16, 26) generating an electric field within an electric field zone (E), through which the porous material (14) provided with powder (12) passes, a lower conveyor (17) capable of moving the porous material (14) provided with powder (12) between the first and second electrodes (16, 26), and a powder distribution zone (P) at which the powder (12) is deposited on the porous material (14), said distribution zone (P) being located upstream of the electric field zone (E), characterised in that the installation further comprises members (15) that extend perpendicularly to the plane of the lower conveyor (17) and come into contact with only one part of said porous material (14).

An installation (100) for impregnating a porous material (14) with powder (12) having first and second electrodes (16, 26) generating an electric field within an electric field zone (E), through which the porous material (14) provided with powder (12) passes. A lower conveyor (17) is capable of moving the porous material (14) provided with powder (12) between the first and second electrodes (16, 26) A powder distribution zone (P) is provided at which the powder (12) is deposited on the porous material (14), the distribution zone (P) being located upstream of the electric field zone (E) The installation further has members (15) that extend perpendicularly to the plane of the lower conveyor (17) and come into contact with only one part of said porous material (14).

### TECHNICAL FIELD

The invention relates to the field of installations for impregnating porous supports with powdery materials.

The invention has numerous applications in many different fields, depending on the type of support and the powder used.

These include the creation of absorbent channels in nappies for infants, for example.

### PRIOR ART

Impregnating a porous support with a powder advantageously makes it possible to modify the properties of the support. To this end, different techniques can be used. In general, these techniques involve forcing the powder into the pores or into the network of fibres of the support by means of a mechanical, pneumatic or electrostatic device, or by means of solvents, etc.

Patent EP 2 331 309 belonging to the applicant describes an installation for impregnating a porous support, comprising two electrodes that are positioned opposite each other and capable of producing an alternating electric field in the region of the clearance between said two electrodes. The support and the powder are trapped between two conveyors capable of transporting the support and the powder to the clearance between the two electrodes. Under the effect of the electric field generated by the electrodes, the powder is moved almost randomly in all directions. The powder thus penetrates the pores of the support to impregnate it across its entire thickness, ideally in a homogeneous manner. An installation of this kind advantageously makes it possible to trap the moving powder and limit losses thereof.

Moreover, an installation of this kind is provided for large supports, typically measuring between 0.5 m and 6 m wide and up to several metres long. Thus, the electrodes are also large in order to establish a substantially homogeneous electric field so that the porous support is impregnated with the powder in a likewise homogeneous manner.

However, it has been noted that moving the powder over the entire width of the porous support causes it to be distributed inconsistently over the support as a whole. For example, the powder tends to escape through the side openings in the installation, which often leads to a lower concentration of powder at the edges of the porous support. It has also been noted that very low-density and very open materials may have a variable thickness depending on how they are arranged on the lower conveyor. As a result, the powder is distributed differently within the porous material depending on how compacted it is.

### SUMMARY OF THE INVENTION

The invention stems from a surprising discovery that by positioning members, which come into contact with only one part of said porous material from below and/or from above, perpendicularly to the plane of the lower conveyor, accumulation of the powder in the region close to these members can be achieved. The applicant had thought that by positioning the members in this manner, the powder would be homogeneously distributed within trap zones defined between said members.

In other words, the applicant has developed an installation for impregnating a porous material with powder, comprising:
first and second electrodes generating an electric field within an electric field zone, said electrodes being arranged on either side of said electric field zone, the porous material provided with powder passing through said electric field zone, the electric field allowing said powder to be moved relative to the porous material,
a lower conveyor capable of moving the porous material provided with powder between the first and second electrodes, and
a powder distribution zone at which the powder is deposited on the porous material, said distribution zone being located upstream of the electric field zone. The powder is deposited homogeneously, i.e. over the entire width of the porous material, or at least over a continuous zone encompassing the region in which impregnation is desired.

The invention is characterised in that the installation further comprises members that extend perpendicularly to the plane of the lower conveyor and come into contact with only one part of said porous material.

According to the invention, “only one part” of the porous material is in contact with members. In other words, the surface of the porous material has first zones that are in contact with the members and second, free zones between the members. These free zones form cavities within which the powder can move and pick up speed to better penetrate the pores of the porous material. In practice, a certain fraction of the porous material comes into contact with the members, and this fraction varies depending on the type of material and the application. By way of example, a proportion of approximately 5 to 30% of the porous material may be in contact with members. Since the members bear on the porous material, the material is squashed slightly. The members therefore advantageously make it possible to smooth out the thickness variations noted when the material is particularly low-density and open.

The invention can therefore be used to obtain a powder distribution profile in which the powder is concentrated on smaller zones formed near the members. The powder distribution profile may be similar to an inverse Gaussian distribution, for which the powder concentration is higher at the ends and lower at the centre. The invention thus makes it possible to more finely control the powder distribution and to create patterns on the porous material.

For example, the invention may be used to impart particular properties on the porous material in highly localised regions. Typically, the invention can be used to trace the absorption channels present in particular in absorbent nappies for babies.

The invention can also be used to create localised zones of powdered-resin reinforcements in a technical textile or in a textile covering as used in roofs of motor vehicles.

In practice, the powder is deposited beforehand in a relatively homogeneous manner on the porous material, which rests on the lower conveyor. The members are then positioned on the assembly formed by the powder-covered porous material, and the whole thing is then exposed to the electric field of the electrodes. The powder is thus moved and picks up enough speed to allow it to penetrate pores of the porous material. Depending on the geometry of the characteristic members, a fraction of the powder deposited downstream of the electric field zone is immobilised between the members and the upper surface of the porous support with a limited ability to move, in particular with a limited ability to penetrate the porous material.

Surprisingly, it has been found that having the members advantageously makes it possible to increase the quantity of powder near these members, despite the material being denser, which would be expected to reduce the quantity of powder penetrating this zone. This unexpected concentration effect can be explained, a posteriori, firstly by a concentration effect of the electric fields in the vicinity and secondly by a retention effect of the denser zone.

Other embodiments of the members are conceivable.

The members may, for example, be located below the porous material, between the lower conveyor and the porous material.

For this embodiment, the porous material rests on the members. The porous material has a variable thickness. The material relaxes between the points of contact with the members, under the effect of its own weight. As before, the zones of contact with the members ultimately have a higher concentration of powder in the material.

The members can also be located above the porous material.

In this embodiment, the porous material rests on the lower conveyor, and the members bear against the porous material from above. Where the members bear on the porous material, this creates zones where the thickness is slightly less and the material is more compacted.

It goes without saying that it is also possible to envisage embodiments in which the members are located both above and below the porous material, so as to obtain an impregnation pattern on each face of the porous material or to increase the penetration of the powder in the porous material by applying pressure to the material from above and below.

According to another embodiment, the members define a set of regions on the surface of the porous material that they face, said regions being closed.

In other words, the members are arranged so as to form, with the aid of the conveyors, closed cavities the bottom of which has a closed contour, for example in a polygonal shape, within which the powder is trapped but can still move.

For this embodiment, it is thus noted that the powder concentrates at the walls of the cavity, thereby imprinting the polygonal pattern on the porous material.

According to another embodiment, the members form a set of protrusions separated from one another.

These protrusions may, for example, take the form of spikes that bear on the porous material in a very localised manner. Alternatively, the protrusions may have a more elongate shape. The contact surface between the members and the porous material then extends in a direction parallel to the plane of the conveyor.

By way of example, the members may be lines parallel to the advancing direction of the porous material or lines transverse to that direction.

According to another embodiment, the members are rigidly connected to the lower conveyor. Advantageously, the installation may further comprise an upper conveyor in order to sandwich and advance the porous material. The members may then be rigidly connected to the upper conveyor. The upper conveyor is, for example, a belt conveyor or a roller.

According to another embodiment, one of the electrodes is cylindrical and the porous material is pressed against this cylinder. The members are then formed by an advantageously dielectric covering of the cylinder, having protruding zones that form, between each other, recessed patterns according to a specific geometry, in order to obtain impregnation patterns with concentrations of powder near the contact zones between the members and the material.

### BRIEF DESCRIPTION OF THE DRAWINGS

Other advantages and features of the invention will become clear upon reading the following description given as a non-limiting, illustrative example with reference to the following accompanying drawings.

FIG. 1 is a schematic longitudinal sectional view of an impregnation installation according to a first embodiment of the invention,

FIG. 2 is a schematic longitudinal sectional view of an impregnation installation according to a second embodiment of the invention,

FIG. 3 is a schematic longitudinal sectional view of an impregnation installation according to a third embodiment of the invention,

FIG. 4 is a perspective view of the top of members according to a first embodiment,

FIG. 5 is a perspective view of the top of members according to a second embodiment, and

FIG. 6 is a perspective view of the top of members according to a third embodiment.

### POSSIBLE WAYS OF CARRYING OUT THE INVENTION

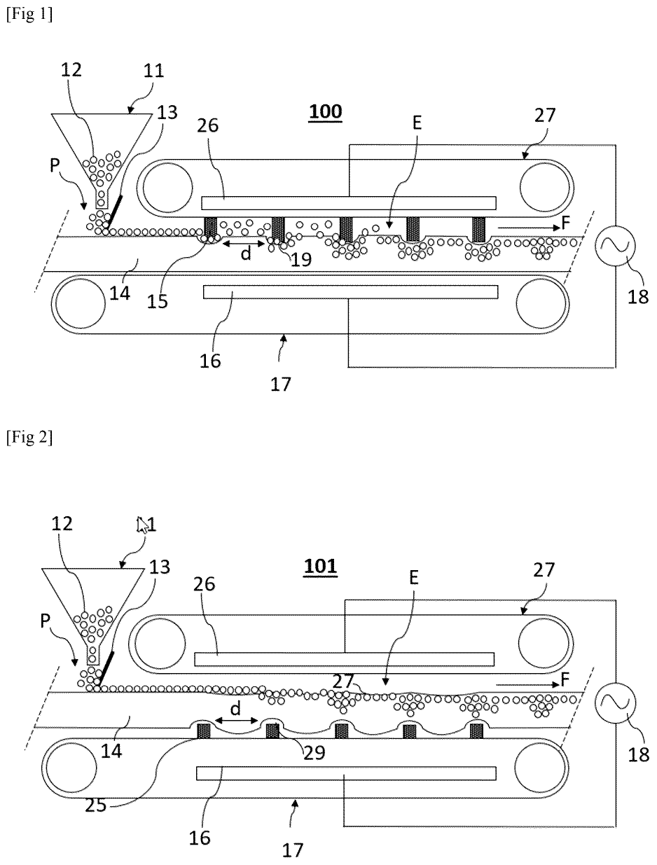

FIGS. 1 to 3 show an impregnation installation 100-102, through which a porous material 14 impregnated with powder 12 passes, said porous material advancing in the direction indicated by the arrow F. The drawings are given by way of illustration. Thus, the proportions may differ from reality; this is solely with the aim of improving the understanding of the invention.

The impregnation installation 100-102 comprises a pair of electrodes 16, 26 facing each other. Each electrode 16, 26 is connected to one of the two terminals of an AC voltage source or generator 18. When supplied with voltage, the electrodes 16, 26 generate an electric field within an electric field zone E.

Each of these two electrodes 16, 26 includes a plate made of a dielectric material, which forms an insulating screen. The screens are placed on the mutually facing faces of the two electrodes 16, 26, so as to electrically insulate them from each other.

In the examples shown, a device for driving the porous material 14 in the advancing direction F comprises two belt conveyors 17, 27, which are arranged opposite each other in a manner substantially parallel to each other. The respective belts of these two conveyors 17, 27 enter the electric field zone E formed between the two electrodes 16, 26, where they advance in parallel and in the same direction F. Once these belts have gripped the porous material 14 between them, they can drive it along the electric field zone E. Advantageously, to ensure that porous materials 14 of different thicknesses can be driven, the spacing between the conveyors 17, 27 and the electrodes 16, 26 is adjustable. Alternatively, the device for driving the porous material may comprise just one lower conveyor 17 on which the porous material 14 rests.

Beforehand, the powder 12 contained in the tank 11 is sprinkled on the porous material 14 on its upper face. The powder distribution zone P, at which the powder 12 is deposited on the porous material 14, is located upstream of the electric field zone E and therefore upstream of the electrodes 16, 26.

The powder is sprinkled uniformly over the entire surface of the material 14 to be impregnated. To do so, the tank 11 may be provided with powder distribution means such as a worm conveyor. Alternatively, a scraper 13 may be arranged at the outlet of the tank 11 so as to spread the powder uniformly over the surface of the porous material 14. In addition, at least some of the powder 12 may not be deposited on the top of the porous material 14 but may be introduced below the porous material 14 before it passes between the electrodes 16, 26, for example by being deposited on the lower conveyor 17 which has been modified accordingly.

The powder 12 may correspond to particles having a diameter in the nanometre range up to a few hundred micrometres. It may consist of polymer particles to be melted in order, after cooling, to form the matrix of a composite material reinforced by the fibres of the porous material 14 or to ensure the cohesion of a textile covering, such as a carpet, by connecting the fibres of this textile covering, for example at a bonding zone. It may also be a clay of the bentonite family or an active ingredient, typically a super-absorbent powder, an antibacterial agent, a colouring agent, a fire retardant, etc.

Furthermore, the material 14 to be impregnated with the powder 12 may be a sheet consisting of fibres. The fibres of the sheet may be in the form of a mat of which the fibres are, for example, bonded together by needling or otherwise. Alternatively, the material 14 may not be fibrous and may consist of a foam, while still being porous so that it can be impregnated.

Members 15, 25, 35, 45 are also present within the electric field zone E. These members extend perpendicularly to the plane of the conveyors 17, 27 and come into contact with the porous material provided with powder 12 such that only one part of the porous material 14 is in contact with the members. Zones are thus left free between the zones of contact with the members 15, 25, 35, 45. These zones are intended for trapping the powder 12 and allowing it to move and pick up enough speed to be able to penetrate the pores of the material 14 and impregnate it.

As shown in FIG. 1, the installation 100 may comprise members 15 positioned between the upper conveyor 27 and the upper face of the porous material 14 covered with powder 12. The members 15 may be rigidly connected to the upper conveyor 27 or independent of it.

When the members 15 are independent of the upper conveyor 27, they are positioned on the surface of the porous material 14 covered with powder 12 before it passes into the electric field zone E.

The members 15 may also be independent of each other. In that case, they are rods in the shape of, for example, a parallelepiped with a height of between 0.2 and 1 cm and a width of between 0.5 and 3 cm. They are generally arranged regularly on the surface of the porous material 14, spaced apart by a distance d. The distance d may, however, vary along the porous material 14, as needed. Thus, they can be arranged with a repeating pattern, for example in order to form a reinforcement, or only at the ends of the material, for example in order to form a leakage barrier.

Cavities or closed regions are thus formed, with the rods providing side delimitation and the upper conveyor 27 providing upward delimitation. The powder 12 is trapped within these cavities. It can move therein and pick up the necessary speed to be able to penetrate the pores of the porous material 14.

Advantageously, a system for adding the rods to the porous material 14 can be installed between the tank 11 and the conveyor 17.

At the zone of contact with the members 15, a deformation 19 is created on the upper part of the porous material 14, thus making the fibres of the porous material 14 denser. These dense zones thus promote the collection of a greater quantity of powder 12. A greater accumulation of powder is then noted in the region of the zone near the members 15. In some cases where compaction is limited, the contact zone under the members also has a higher concentration of powder. It can be assumed that the members influence the distribution of the electric field by distorting the equipotentials, thus imposing specific movements on the powder and overall helping to concentrate the powder.

The members 15 may also be interconnected by a frame or a support. It is then sufficient to arrange the frame on the upper face of the porous material 14. To this end, a system for adding the plates can be installed upstream of the conveyor 17 for depositing a new plate as the fibrous material 14 advances along the conveyor 17.

In this case, the frame is a perforated plate in which the members 15 form the solid parts. The empty or perforated parts then form, together with the upper conveyor 27, the cavities for trapping the powder 12. The perforated parts can take various shapes such as circles, squares, cells or more generally any polygonal shape.

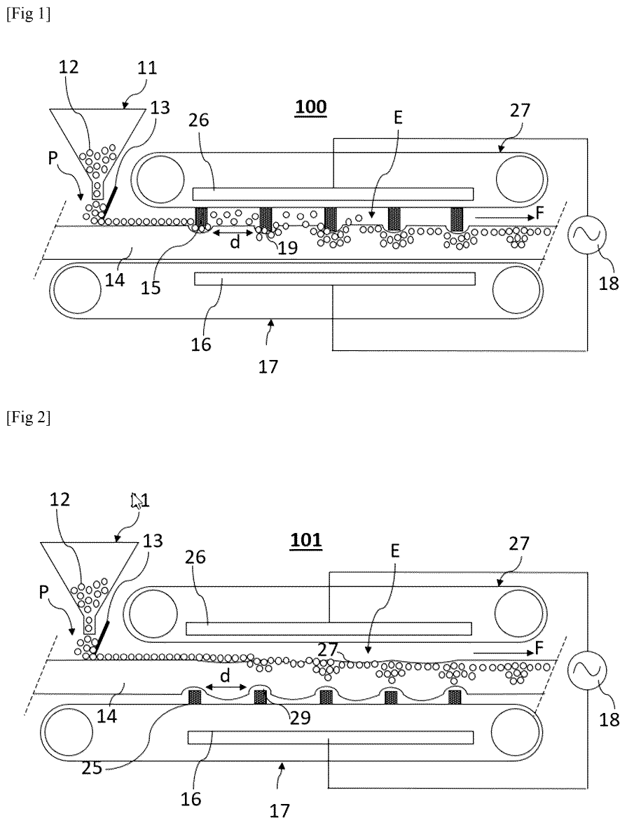

When the members 15 are rigidly connected to the upper conveyor 27, several configurations can be envisaged. The upper conveyor 27 may take the form of a belt conveyor, the smooth belt of which has been replaced by a belt having protrusions extending perpendicularly to the plane of the conveyor, as shown in FIGS. 4 to 6. Alternatively, the upper conveyor 27 may be a roller whose surface is etched to form the protrusions, or a roller covered with a flexible plate having the protrusions.

Thus, as shown in FIG. 4, the protrusions may be contiguous, thus forming a grid delimiting the regions 31 within which the powder is trapped.

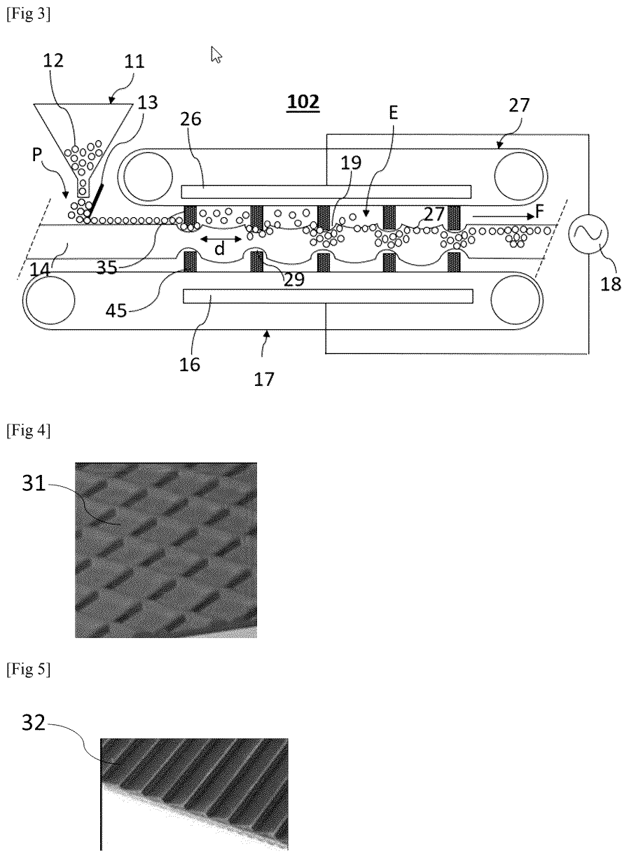

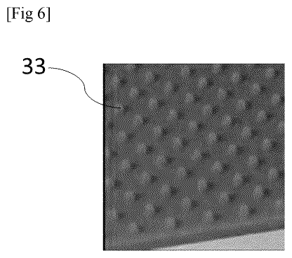

Alternatively, as shown in FIGS. 5 and 6, the protrusions are separated from each other. They may, for example, have an elongate shape 32, as shown in FIG. 5. In that case, the protrusions are in the form of lines parallel with one another, spaced apart by a distance of between 0.1 and 10 cm.

The protrusions may also be in a spike shape 33, as shown in FIG. 6. In that case, the protrusions are substantially conical or frustoconical so as to limit contact with the porous material 14 to a very restricted and very precise zone, making it possible to obtain a dotted pattern.

For these three examples, the height of the protrusions is between 0.1 and 1 cm.

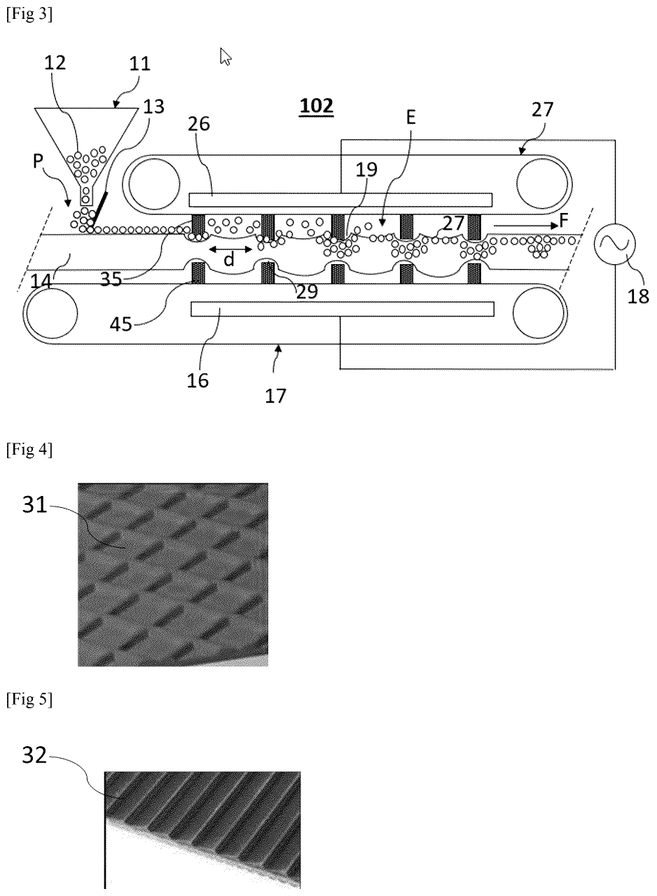

As shown in FIG. 2, the installation 101 may alternatively comprise members 25 positioned between the lower conveyor 17 and the lower face of the porous material 14. As in FIG. 1, the members 25 may be rigidly connected to the lower conveyor 17 or independent of it.

When the members 25 are independent of the lower conveyor 27, they are positioned on the lower conveyor 27 before being covered with the porous materials 14.

The members 15 may also be independent of each other. The closed cavities are thus formed, with the members 25 providing side delimitation and the upper conveyor 27 providing downward delimitation. The powder 12, which passes through the porous material 14 or is arranged under the porous material 14 beforehand, is trapped within these cavities. It can move therein and pick up speed again to be able to penetrate the pores of the porous material 14.

At the zone of contact between the members 25 and the lower face of the porous material 14, a deformation 29 is created, rendering the fibres of the porous material 14 denser. These dense zones thus promote the collection of a greater quantity of powder. A greater accumulation of powder is then noted in the region of the zone of the porous material 14 near the members 25.

The members 25 may also be interconnected by a frame or a support. It is then sufficient to arrange the frame on the lower conveyor 17. The perforated parts then form, together with the lower conveyor 17, the cavities for trapping the powder 12.

When the members 25 are rigidly connected to the lower conveyor 17, the lower conveyor may take the form of a belt conveyor, the smooth belt of which has been replaced by a belt having protrusions, as shown in FIGS. 4 to 6. The members 25 thus advance together with the lower conveyor 17, at the same time as the porous material 14.

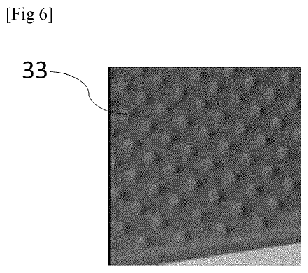

As shown in FIG. 3, the installation 102 may comprise members 35, 45 positioned between the lower conveyor 17 and the lower face of the porous material 14 and also between the upper conveyor 27 and the upper face of the porous material 14. The members 35, 45 may be configured the same way as described with reference to FIGS. 1 and 2. The upper members 35 and lower members 45 may be aligned or staggered, depending on the desired results.

In practice, the conveyors 17, 27 bring together the porous material 14, the powder 12 and, as applicable, the members 15, 25, 35, 45 within the electric field zone E and advance them therein in a substantially continuous manner. Within the electric field zone E, the alternating electric field generated by the electrodes 16, 26 moves the powder within the regions or cavities delimited by the members 15, 25, 35, 45 and the conveyors 17, 27 and forces the powder 12 into the pores of the porous material 14. As the field generated between the electrodes 16, 26 is an alternating field, it has a maximum, the value of which is selected depending on the application, in particular depending on the specific features of the porous material 14 and/or those of the powder 12. Values of this maximum of between 0.10 and 20 kV/mm have been appropriate in many applications. Furthermore, the supply voltage of the electrodes 16, 26 may take various forms. For example, the generator 18 may produce a sinusoidal voltage, a square-wave voltage or a sawtooth voltage.

The frequency of the electric field generated between the electrodes 16, 26 is selected depending on the application. Frequencies of between 50 and 60 Hz have been appropriate in many applications.

The desired impregnation is obtained only after the fibrous material 14 and the powder 12 have been exposed to the alternating electric field for a sufficient amount of time. This amount of time depends on the application and other process parameters.

1. An installation for impregnating a porous material with powder, comprising:
first and second electrodes generating an electric field within an electric field zone, said electrodes being arranged on either side of said electric field zone, the porous material provided with powder passing through said electric field zone, the electric field allowing said powder to be moved relative to the porous material
a drive device including a lower conveyor, which is arranged under the porous material and is capable of moving the porous material provided with powder between the first and second electrodes, and
a powder distribution zone at which the powder is deposited over the width of the porous material, said distribution zone being located upstream of the electric field zone, wherein the installation further comprises members that extend perpendicularly to the plane of the conveyor and come into contact with only one part of said porous material.

2. The installation according to claim 1, wherein the members are located below the porous material, between the lower conveyor and the porous material.

3. The installation according to claim 1, wherein the members are located above the porous material.

4. The installation according to claim 1, wherein the members define a set of regions on the surface of the porous material that they face, said regions being closed.

5. The installation according to claim 1, wherein the members form a set of protrusions separated from one another.

6. The installation according to claim 1, wherein the contact surface between the members and the porous material extends in a direction parallel to the plane of the lower conveyor.

7. The installation according to claim 1, wherein the members are rigidly connected to the lower conveyor.

8. The installation according to claim 1, wherein said installation further comprises an upper conveyor, the members being rigidly connected to the upper conveyor.
